(19) United States
(12) Patent Application Publication
(10) Pub. No.: US 2007/0177694 A1
(43) Pub. Date: Aug. 2, 2007

(54) Method and apparatus for signal processing in RFID receivers

(75) Inventors: Yuri Okunev, Middle Island, NY (US); Kevin J. Powell, Annapolis, MD (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Symbol Technologies, Inc., Holtsville, NY (US)

(21) Appl. No.: 11/332,220

(22) Filed: Jan. 17, 2006

(51) Int. Cl. H04L 27/22

(52) U.S. Cl. 375/333; 340/10.1; 340/572.4

(57) ABSTRACT

The present invention provides methods and apparatuses for demodulation and decoding of backscattered RFID tag signals, represented by their in-phase and quadrature components at the output of the demodulator in the receiver portion of a reader interrogator. Correlation coefficients for the in-phase and quadrature components of the received signal are calculated over a shifted bit interval. Performing a correlation over a shifted bit interval relative to the real bit interval allows the base-band receiver to involve a two-bit interval in making a decision about each transmitted bit. In contrast, in a conventional decoding algorithm, a single bit interval is involved in the decision-making process. Thus, the current method provides a 3 dB energy gain compared to the conventional method. A single zero-mean reference signal is used to compute correlation coefficients, eliminating constant components of the received signal, and simplifying digital implementation of the base-band receiver. A value of the output data is determined based on the combined correlation coefficients.

### BACKGROUND OF THE INVENTION

1. Field of the Invention

The present invention relates generally to telecommunications apparatus, systems and methods. More specifically, the invention relates to Radio Frequency Identification (RFID) receivers that detect, demodulate and decode signals from RFID tags.

2. Background Art

Radio frequency identification (RFID) technology is a wireless telecommunications technology where signal data is transmitted between various system elements via radio channels with variable parameters.

In a RFID system, the presence of an RFID tag, and therefore the presence of the item to which the tag is affixed, may be checked and monitored wirelessly by devices known as “readers.” Readers typically have one or more antennas transmitting radio frequency signals to which tags respond. Since the reader “interrogates” RFID tags, and receives signals back from the tags in response to the interrogation, the reader is sometimes termed as “reader-interrogator” or simply “interrogator”.

With the maturation of RFID technology, efficient communication between tags and interrogators has become a key enabler in supply chain management, especially in manufacturing, shipping, and retail industries, as well as in building security installations, healthcare facilities, libraries, airports, warehouses etc.

In a RFID system, an interrogator first transmits a continuous wave (CW) or modulated radio frequency (RF) signal to a tag. The tag receives the signal, and responds by modulating the signal according to the reflection coefficient of the tag's antenna, thereby backscattering an information signal to the interrogator. Once an interrogator receives signals back from the tag, the interrogator demodulates, decodes and passes that information in digital form to a host computer, which further processes the information.

Development of reliable demodulation and decoding procedures for encoded signals is an important problem of all wireless system design, including wireless RFID systems. A RFID communication channel is usually plagued with severe interference, multipath propagation, and fast fading, especially when a tag or/and a reader are moving. Additionally, a tag backscatter signal has considerable variation in its parameters. A tag backscatter signal may have random delay, amplitude, frequency and phase, which are rapidly changing functions of time.

A recent RFID standard specifies communication parameters for a 2^{nd} generation of RFID systems, known as “Gen2 RFID systems” with extended data transmission capabilities, including different modulation and encoding techniques, and a wide spectrum of bit rates. High speed data transmission modes need more sophisticated signal processing procedures which provide the highest possible performance in terms of bit error rate (BER) and block error rate (BLER) in both tag and reader sides.

An FM0 modulation/encoding mode is recommended by the Gen2 RFID standard for high bit rates. In FM0 mode, the quadrature components, referred to as the I/Q components, of tag signals in the reader receiver have a single subcarrier cycle. Conventionally, I/Q component of similar signals are processed using an algorithm known as the “optimal incoherent algorithm”. This algorithm is based on the correlation of the received signal with two reference signals corresponding to two possible replicas of the transmitted signal.

A disadvantage of using the conventional incoherent algorithm in the FM0 mode is that one of the references does not have a zero mean, and, therefore, correlation of the received I/Q signal with this non-zero-mean replica does not remove a constant DC component of the I/Q transforms. However, in a typical RFID environment, even after eliminating the DC component, the conventional incoherent algorithm can only achieve desired performance with a comparatively high signal-to-noise ratio (SNR) when the communication distance becomes relatively large. Additionally, the requirement for two reference correlation channels for each quadrature component complicates receiver implementation.

Thus, new high-speed RFID systems need more efficient techniques for demodulation and decoding of backscatter signals in readers. What is desired are improved techniques that satisfy one or more of the following: 1) providing considerable energy gain compared to conventional approaches; 2) providing simplified hardware implementation based on quadrature components with minimum correlation computations; 3) providing high performance even in the presence of DC components in the I/Q transforms.

### SUMMARY OF THE INVENTION

Methods, systems, and apparatuses for the operation and implementation of RFID reader interrogators capable of demodulating and decoding encoded backscattered signals from RFID tags are described.

In an example aspect, a reader receiver calculates correlation coefficients for in-phase and quadrature components (denoted as I and Q respectively) of a signal received from a tag. The reader receiver further computes two cross correlations, and determines the value of the resulting output data from a combination of the cross correlations. A single reference signal is used to generate the correlation coefficients as opposed to two reference signals required by conventional decoding methods.

One or more advantages are realized when demodulating (decoding) the backscatter tag signal according to an embodiment of the present invention, where the back scatter tag signal is represented by its quadrature components in the receiver. In a first example aspect, considerable energy gain as compared to conventional receivers is provided. In another example aspect, a simple implementation of the receiver in a digital signal processing (DSP) environment is enabled.

In an aspect of the present invention, a single mean-zero reference is utilized. This provides for simplification of the base-band portion of the receiver as compared to a conventional two-reference receiver. In a further aspect, uncertain constant components present in the I/Q transforms are eliminated.

In another aspect of the present invention, correlation coefficients are calculated between the received I/Q components and the reference signal within an interval shifted by a half-bit relative to the current bit interval. A two-bit interval is used to make a decision about each transmitted bit. Thus, a decision about a current bit is based on correlation coefficients computed for two adjacent bit intervals (the present bit interval, and the prior bit interval). This provides an energy gain with respect to conventional receiver implementations.

These and other aspects, advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates an environment where RFID readers communicate with an exemplary population of RFID tags, according to an embodiment of the present invention.

FIG. 2 shows a block diagram of the receiver portion of a RFID reader interrogator.

FIGS. 3A and 3B show various sequences of a FM0 encoded signal that is transmitted from a RFID tag to a RFID reader interrogator.

FIG. 4A shows a flowchart providing an example embodiment of the decoding algorithm of a conventional receiver.

FIG. 4B shows a flowchart providing an example embodiment of the decoding algorithm of the present invention.

FIG. 5 shows a block diagram of the base-band digital receiver portion of a conventional RFID reader-interrogator.

FIG. 6 shows a block diagram of the base-band digital receiver portion of a RFID reader-interrogator according to an embodiment of the present invention.

FIG. 7 illustrates various signal waveforms pertaining to decoding operations performed by the RFID base-band digital receiver of FIG. 6.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

Introduction

The present invention relates to wireless telecommunications apparatus, systems and methods which implement data transmission via radio channels with variable parameters. More specifically, the invention relates to the digital implementation of the base-band receiver portion of Radio Frequency Identification (RFID) reader-interrogators, providing detection, demodulation and/or decoding of encoded signals from tags.

Interaction between tags and reader-interrogators takes place according to one or more RFID communication protocols, such as those approved by the RFID standards organization EPCglobal (EPC stands for Electronic Product Code). One example of a communication protocol is the widely accepted emerging EPC protocol, known as Generation-2 Ultra High Frequency RFID (“Gen 2” in short). Gen 2 allows a number of different tag “states” to be commanded by reader interrogators. A detailed description of the EPC Gen 2 protocol may be found in “EPC™ Radio-Frequency Identity Protocols Class-1 Generation-2 UHF RFID Protocol for Communications at 860 MHz-960 MHz,” Version 1.0.9, and published 2004, which is incorporated by reference herein in its entirety. The Gen 2 specification defines frequencies, modulation, data coding, RF envelope, data rates, and other parameters required for RF communications. Embodiments of the present invention may be implemented by reader-interrogators communicating according to the Gen 2 protocol and/or according to other communication protocols.

The present invention provides methods and apparatuses for demodulation and decoding of backscattered tag signals, represented by their in-phase and quadrature components in the receiver portion of a reader interrogator. It is noted that the receiver portion of the reader interrogator is often referred to as “reader receiver” in the present application.

In a RFID system, once a reader interrogator receives a modulated response signal from a RFID tag, the reader performs considerable amount of data processing to demodulate and decode the received signal. Correlation algorithms are often used in the receiver as part of the decoding procedure.

The methods and systems described in the present application have several advantages compared to conventional correlation methods. Embodiments provide stable performance and reliable decision making even with a large variation of backscattered signal parameters. Embodiments of the present invention provide for both reliable data decoding and simple device implementation of the base-band portion of reader receivers.

It is noted that references in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Example RFID System Embodiment

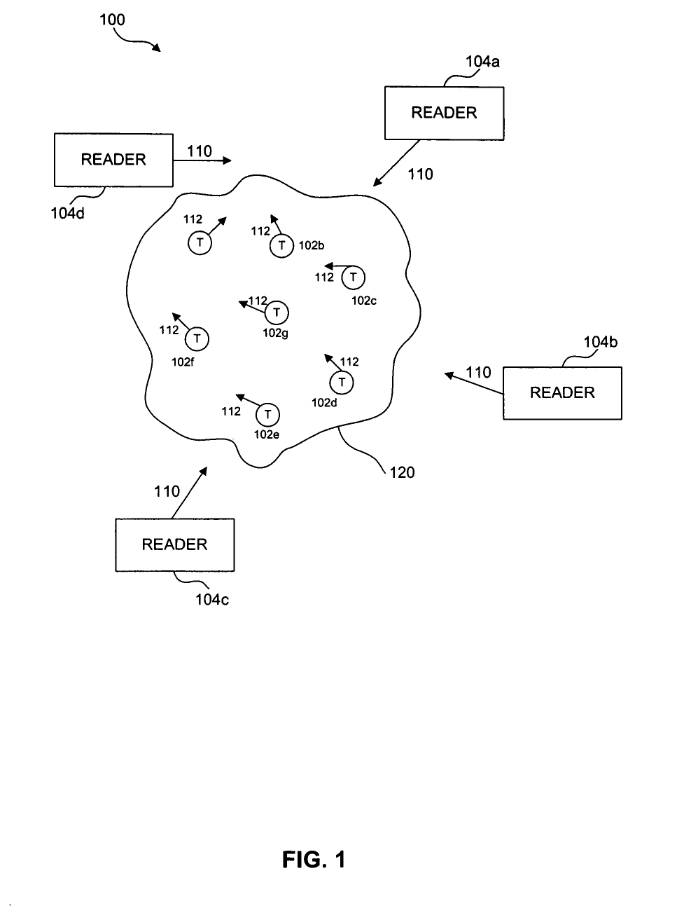

FIG. 1 describes an example environment 100, where the present invention may be implemented. Environment 100 includes a population 120 of RFID tags 102a-g, and RFID readers 104a-d. Readers 104a-d may operate independently, or may be connected together to form a reader network. Although not shown explicitly in FIG. 1, each of readers 104a-d is coupled to one or more antennas. When a reader 104 transmits an interrogation signal 110 through its corresponding antenna, one or more tags 102 respond by sending a signal 112 back to the reader. Signal 112 contains tag identification data, that can be decoded by the interrogating reader 104 in order to retrieve relevant information about an item to which tag 102 is attached, such as item price, item location etc.

Example Conventional RFID Reader Embodiment

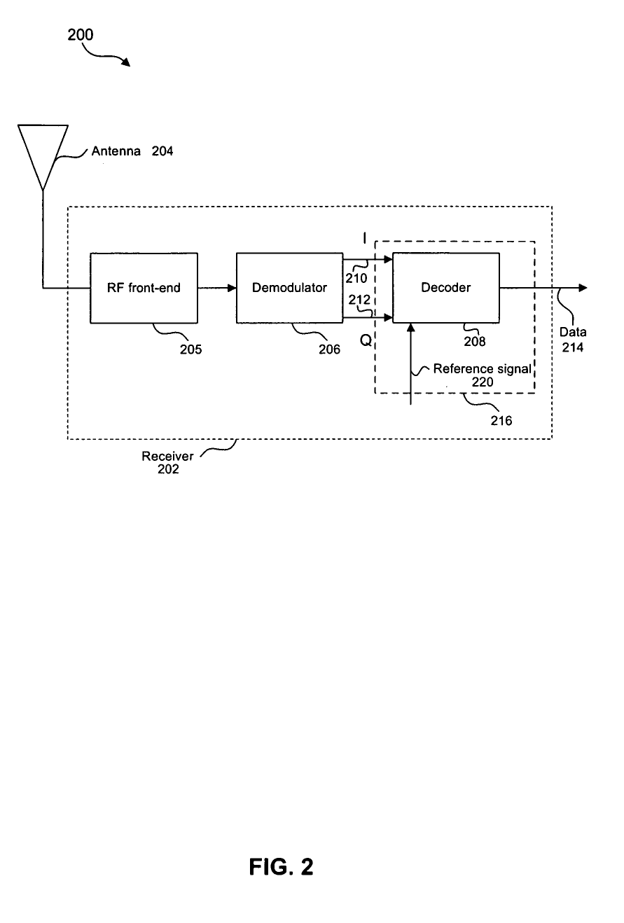

FIG. 2 shows an example block diagram of the receiver portion of a conventional RFID reader 200. Reader 200 typically includes one or more antennas 204, one or more receivers 202, one or more transmitters, one or more memory units, and one or more processors (transmitters, memory units, and processors are not shown in FIG. 2). As shown in the example of FIG. 2, receiver 202 includes a RF front-end 205, a demodulator 206, and a decoder 208. These components of reader 200 may include software, hardware, and/or firmware, or any combination thereof, for performing their functions, which are described in further detail in subsequent sections herein.

Antenna 204 is used for communicating with tags 102 and/or other readers 104. RF front-end 205 typically includes one or more of antenna matching elements, amplifiers, filters, an echo-cancellation unit, and/or a down-converter. In an embodiment, RF front-end 205 receives the tag response signal through antenna 204 and down-converts the response signal to a frequency range amenable to further signal processing.

Demodulator 206 is coupled to an output of the RF front-end 205, and receives the modulated tag response signal from RF front-end 205. Demodulator 206 demodulates the tag response signal. At the output of demodulator 206, the tag response signal is represented by an in-phase component 210 (denoted as I), and a quadrature component 212 (denoted as Q).

Note that the in-phase and quadrature components of a received encoded signal have a quadrature phase relationship (i.e., 90° out of phase) with respect to each other. Thus, both are referred as quadrature components of the received signal. For sake of differentiation and clarity, one of the components is referred to as an in-phase component (I), and the other component is referred to as a quadrature component (Q) herein.

Decoder 208 is coupled to an output of demodulator 206 and receives in-phase and quadrature components 210 and 212, respectively. Gen 2 formatted tag response signals encode backscattered data as either FM0 modulation of the baseband signal or Miller modulation of a subcarrier, as dictated by the reader. Different sub-components included within decoder 208 are further described below with reference to subsequent figures. Decoder 208 executes one or more algorithms in order to generate decoded data signal 214.

Signal 220 is an a priori known reference signal. As mentioned before, conventional reader receivers generate and save multiple reference signals 220, adaptively adjust reference signal parameters, and multiply backscattered tag signal and reference signals in order to calculate correlation coefficients.

Signal components 210 and 212, reference signal 220, and decoder 208 comprise the base-band portion 216 of receiver 202. Embodiments for base-band portion 216 are described in further detail below.

Example RFID Data Encoding Techniques

FM0 baseband modulation is a commonly used data encoding technique used in backscattered signals received by an RFID reader-interrogator from a RFID tag. An FM0 mode of operation is capable of delivering a very high data rate in Gen 2 RFID systems. The present invention applies to FM0 encoding and to other modulation schemes, including any other modulation technique that utilizes two completely correlated signal waveforms to generate each transmitted symbol.

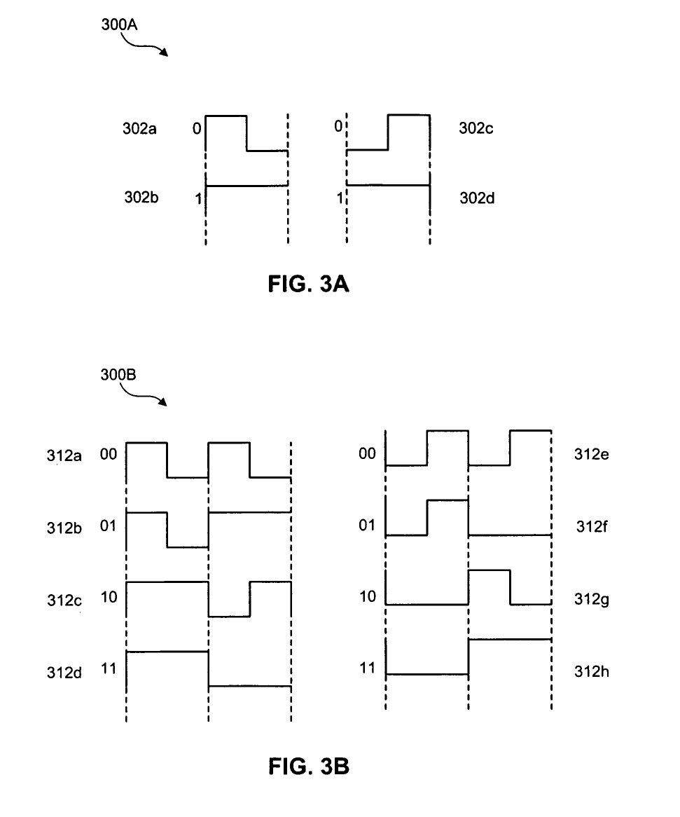

FIGS. 3A and 3B illustrate FM0 encoded data waveforms. FM0 encoding is also known as bi-phase space encoding. FM0 inverts the baseband phase at every symbol boundary. Additionally, a data symbol representing ‘0’, also known as data-0, undergoes a mid-symbol phase inversion. A data symbol representing ‘1’, also known as data-1, does not undergo this additional mid-symbol phase inversion. Data-0 symbols 302a and 302c are two possible representations of a data ‘0’ in FM0 encoded symbols. Data-1 symbols 302b and 302d are two possible representations of a data ‘1’ in FM0 encoded symbols.

FIG. 3B shows example FM0 sequences generated by concatenating FM0 symbols depicted in FIG. 3A. Sequences 312a and 312e are “00” data sequences, sequences 312b and 312f are “01” data sequences, sequences 312c and 312g are “10” data sequences, and sequences 312d and 312h are “11” data sequences. For example, sequence 312c is generated by concatenating a data-1 symbol 302b and a data-0 symbol 302c. As shown in FIG. 3B, there is a phase inversion in each sequence at the boundary between symbols, as indicated at the center vertical dotted line through each of sequences 312a-312h.

Once a reader interrogator receives a modulated response signal from a RFID tag, the reader performs a large amount of data processing to demodulate and decode the received signal.

Example Conventional RFID Data Decoding Techniques and Receivers

Embodiments of the present invention are applicable to Gen2 RFID modulation and encoding modes, including ASK and PSK modulation, and FM0 encoding. Embodiments discussed here are adaptable to further RFID protocol, modulation schemes, and encoding methods, as would be understood by persons skilled in the relevant art(s) by the teachings herein.

Receiver 202 of FIG. 2 provides for a linear transformation of a received high-frequency signal to base-band components I and Q. As mentioned previously, I and Q have a quadrature phase relationship. Herein, we refer to the in-phase component as I, and quadrature component as Q. Signal components I and Q, as represented by their samples, do not contain a constant DC component. However, one or more of the reference signals used for computing correlation coefficients may contain a non-zero DC component.

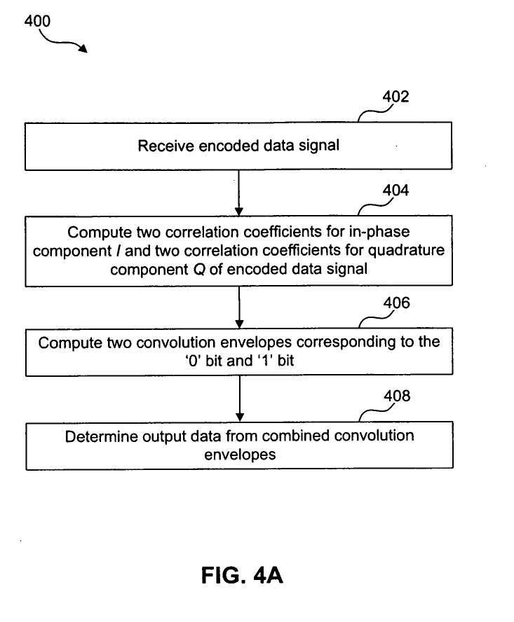

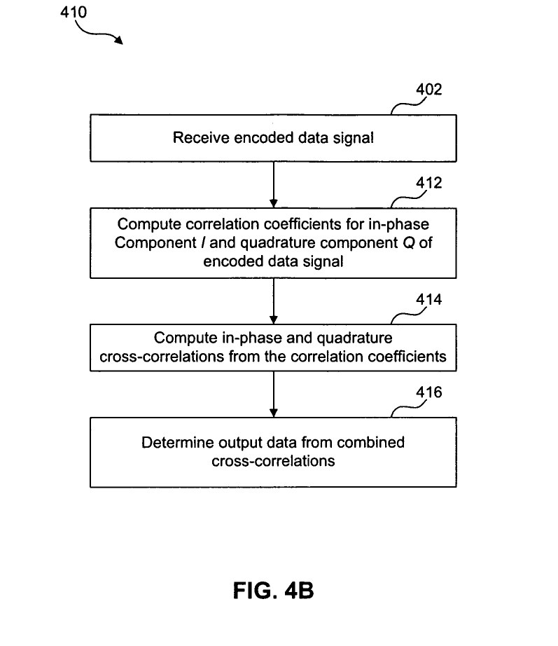

FIG. 4A shows a flowchart 400 providing steps for decoding received tag signals in a conventional RFID reader receiver.

Flowchart 400 begins with step 402. In step 402, an encoded data signal is received. For example, according to the present invention, a RFID reader-interrogator receives the in-phase and quadrature components of an encoded data signal from a RFID tag.

In step 404, two correlation coefficients for the in-phase component I and two correlations coefficients for the quadrature component Q of the encoded data signal are computed. For example, in a conventional RFID receiver, the following correlation coefficients are calculated: 1) correlation coefficient C_{I0} comprising in-phase signal component I and a reference signal R0 corresponding to the ‘0’ bit; 2) correlation coefficient C_{I1} comprising in-phase signal component I and a reference signal R1 corresponding to the ‘1’ bit; 3) correlation coefficient C_{Q0} comprising quadrature signal component Q and a reference signal R0 corresponding to the ‘0’ bit; and 4) correlation coefficient C_{Q1} comprising quadrature signal component Q and a reference signal R1 corresponding to the ‘1’ bit. Note that in a conventional receiver, the above mentioned correlation coefficients are calculated within the real symbol interval.

In step 406, two convolution envelopes corresponding to the ‘0’ bit and ‘1’ bit are computed. For example, the receiver computes convolution envelope M0(n) by summing the squares of the correlation coefficients C_{I0} and C_{Q0}, and convolution envelope M1(n) by summing the squares of the correlation coefficients C_{I1} and C_{Q1}.

In step 408, the output data from the combined convolution envelopes is determined.

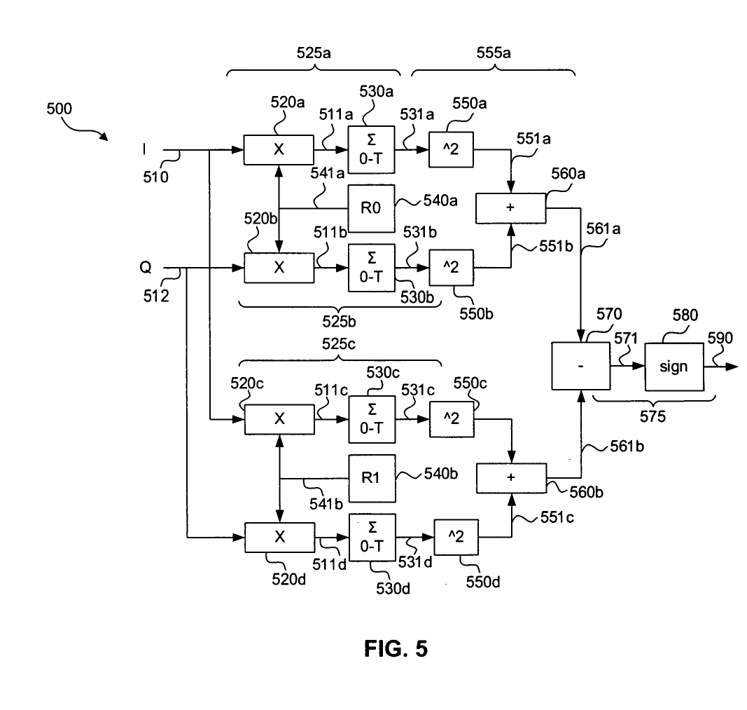

FIG. 5 shows the base-band portion 500 of a conventional receiver used in wireless communication systems, configured to execute the steps of the correlation algorithm described by flowchart 400. As shown in FIG. 5, base-band portion 500 includes a first in-phase correlator 525a and a second in-phase correlator 525b. First in-phase correlator 525a comprises digital multiplier 520a and adder-accumulator 530a. Second in-phase correlator 525b comprises digital multiplier 520b and adder-accumulator 530b. Baseband receiver 500 also includes a first quadrature correlator 525c and a second quadrature correlator 525d. First quadrature correlator 525c comprises digital multiplier 520c and adder-accumulator 530c. Second quadrature correlator 525d comprises digital multiplier 520d and adder-accumulator 530d.

Receiver 500 also includes an in-phase convolution envelope generation module 555a and a quadrature convolution envelope generation module 555b. Module 555a comprises a first in-phase square generator 550a, a second in-phase square generator 550b, and an adder 560a. Similarly, module 555b comprises a first quadrature square generator 550c, a second quadrature square generator 550d, and an adder 560b. In addition, receiver 500 includes a decision module 575, which comprises a subtracter 570 and sign generator logic module 580. Furthermore, receiver 500 includes reference template generator modules 540a and 540b.

As shown in FIG. 5, digital multipliers 520a and 520c receive in-phase signal component 510, and digital multipliers 520b and 520d receive quadrature signal component 512. Signals 510 and 512 are represented by the k-th samples of the in-phase and quadrature components at the output of the demodulator 206 (denoted by I(kΔt) and Q (kΔt) respectively), where k=1, 2, . . . K, and K is the number of samples in the bit interval with duration T. T is the time period representing the length of a data symbol. Note that the terms ‘bit’ and ‘symbol’ are used interchangeably for the purpose of the description herein.

R0(kΔt) and R1(kΔt) are the k-th samples of reference signals corresponding to “0” and “1” bits, respectively. For the FM0 waveforms, reference signals R0 and R1 (signals 302a and 302b in FIG. 3A, respectively) are expressed by the following equations:
R0(kΔt)=sign(sin kΔtΩ), (Equation 1)
R1(kΔt)=1, (Equation 2)
where Ω=2π/T is the subcarrier frequency, T is the length of a data symbol, and Δt=T/K is the sampling interval.

As shown in FIG. 5, reference template generator module 540a generates reference signal R0, shown as reference signal 541a, and reference template generator module 540b generates reference signal R1, shown as reference signal 541b.

Digital multiplier 520a of correlator 525a receives reference signal 541a, and multiplies reference signal 541a with received in-phase signal 510 to generate the product [I(kΔt)*R0(kΔt)], denoted by signal 511a.

Adder-accumulator 530a receives signal 511a and performs a summation over all samples within the n-th bit interval (i.e. from time t=(n−1)T to t=nT) to generate the first in-phase correlation coefficient C_{I0} corresponding to bit ‘0’, denoted by signal 531a, according to the equation,

$${C}_{I 0} ( n ) = {\sum }_{k = 1}^{{K}_{n}} {I ( k Δ t )}^{*} R 0 ( k Δ t ) \qquad ( Equation 3 )$$

Similarly, digital multiplier 520b of correlator 525b receives reference signal 541a, and multiplies reference signal 541a with received quadrature signal 512 to generate the product [Q(kΔt)*R0(kΔt)], denoted by signal 511b.

Adder-accumulator 530b receives signal 511b and performs summation over all samples within the n-th bit interval [i.e. from time t=(n−1)T to t=nT] to generate the first quadrature correlation coefficient C_{Q0} corresponding to bit ‘0’, denoted by signal 531b, according to the equation,

$${C}_{Q 0} ( n ) = {\sum }_{k = 1}^{{K}_{n}} {Q ( k Δ t )}^{*} R 0 ( k Δ t ) \qquad ( Equation 4 )$$

Two additional correlation coefficients are generated, one each for the in-phase and quadrature components, corresponding to the bit ‘1’ in a manner similar to what was described above for bit ‘0’, by multiplying and accumulating received signal components with reference signal R1. Thus, this description is not provided in full for reasons of brevity. It should be noted though that, as long as the reference signal R1 is not a zero-mean waveform (see Equation 2), generation of these correlation coefficients (in contrast to correlation coefficients according to Equations 3 and 4) does not eliminate constant components of the received in-phase and quadrature components. Thus, a conventional receiver must have special means for constant component elimination.

Adder-accumulator 530c outputs the second in-phase correlation coefficient C_{I1} corresponding to bit ‘1’, denoted by signal 531c, according to the equation,

$${C}_{I 1} ( n ) = {\sum }_{k = 1}^{{K}_{n}} {I ( k Δ t )}^{*} R 1 ( k Δ t ) \qquad ( Equation 5 )$$

Adder-accumulator 530d outputs the second quadrature correlation coefficient C_{Q1} corresponding to bit ‘1’, denoted by signal 531d, according to the equation,

$${C}_{Q 1} ( n ) = {\sum }_{k = 1}^{{K}_{n}} {Q ( k Δ t )}^{*} R 1 ( k Δ t ) \qquad ( Equation 6 )$$

Convolution envelope generator module 555a receives signals 531a and 531b, computes the squares of those signals using square generators 550a and 550b respectively, combines the squares using adder 560a, and outputs the summation of the squares in the form of combined signal M0(n), denoted by signal 561a. For bit ‘0’, the convolution envelope M0(n) is calculated according to,
M0(n)=[C_{I0}(n)]²+[C_{Q0}(n)]². (Equation 7)

Similarly, convolution envelope generator module 555b receives signals 531c and 531d, computes the squares of those signals using square generators 550c and 550d respectively, combines the squares using adder 560b, and outputs the summation of the squares in the form of combined signal M1(n), denoted by signal 561b. For bit ‘1’, the convolution envelope M1(n) is calculated according to,
M1(n)=[C_{I1}(n)]²+[C_{Q0}(n)]² (Equation 8)

Decision module 575 receives signals 561a and 561b. Subtracter module 570 generates a difference of signals 561a and 561b, and outputs a difference signal 571. In an embodiment, sign generator logic module 580 assigns a data value of ‘0’ if the sign of difference signal 571 is negative, and a data value of ‘1’ if the sign is positive. Decision module 575 outputs a decision signal 590, which also represents the transmitted output bit. The operation of decision module 575 can be expressed mathematically by the following equation,
Decision signal 590=Decision(n)=sign[M1(n)+M0(n)]. (Equation 9)

Note that in an embodiment, decision module 575 performs step 408 of flowchart 400 shown in FIG. 4A.

### EXAMPLE EMBODIMENTS OF THE PRESENT INVENTION

Embodiments of the present invention provide for improved signal processing over conventional techniques, such as shown in FIG. 4A. FIG. 4B shows flowchart 410 providing example steps of the signal processing method according to the present invention. The steps of flowchart 410 can be performed by embodiments of readers described herein. Other structural and operational embodiments will be apparent to persons skilled in the relevant art(s) based on the following discussion related to flowchart 400B. The steps shown in FIG. 4B do not necessarily have to occur in the order shown.

The first step in flowchart 410 is step 402, which is generally the same as step 402 in flowchart 400 (FIG. 4A). In step 402, an encoded data signal is received. For instance, if the receiver is included in a RFID reader interrogator, then it can receive backscattered data from a RFID tag in response to the interrogation command issued by the interrogator. Furthermore, the receiver can convert the encoded data signal into an in-phase component I and a quadrature component Q, such as in-phase and quadrature components 210 and 212 shown in FIG. 2.

In step 412, correlation coefficients are computed for the in-phase component I and the quadrature component Q of the encoded data signal. For example, in-phase correlation coefficient C_{I0} and quadrature correlation coefficient C_{Q0} are calculated in this step.

In step 414, in-phase and quadrature cross correlations are computed from the correlation coefficients.

In step 416, an output data is determined from the combined cross correlations.

Thus, note that in step 412, for each of the I and Q components, a single correlation coefficient is calculated (C_{I0} and C_{Q0}), in contrast to calculating a pair of correlation coefficients for each of the I and Q components (C_{I0}, C_{I1}, C_{Q0}, and C_{Q1}), as in step 404 of FIG. 4A. Furthermore, in step 414, for each of the I and Q components, a single cross correlation value is computed (MI and MQ), in contrast to computing the squares of all four correlation coefficients (C_{I0}², C_{I1}², C_{Q0}², and C_{Q1}²) in order to generate the convolution envelopes M1 and M0, as in step 406 of FIG. 4A.

In an embodiment, base-band portion 216 of FIG. 2 performs the calculations/operations of steps 402, 412, 414, and 416. Detailed embodiments for base-band portion 216, and further detail regarding the steps of flowchart 410 are described in further detail below.

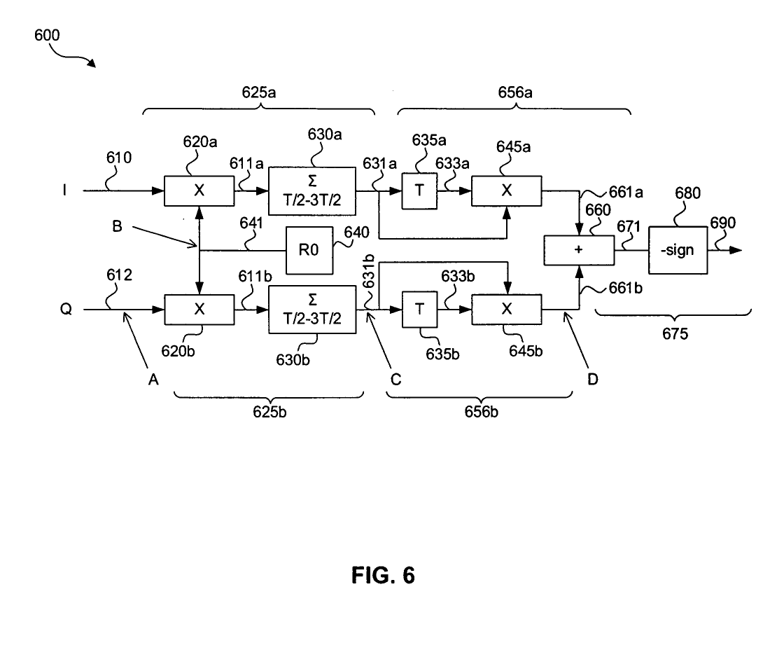

FIG. 6 depicts a block diagram of the base-band portion 600 of a wireless digital receiver according to the present invention, configured to execute the steps of the decoding algorithm described by flowchart 410. As shown in FIG. 6, base-band portion 600 includes an in-phase correlator 625a, a quadrature correlator 625b, a first delay module 635a, a second delay module 635b, a first multiplier 645a, a second multiplier 645b, and a decision module 675. Receiver 600 also includes a template generator module 640.

A correlator is a receiver component that demodulates an incoming communication signal, and measures the similarity of the incoming signal and a stored reference signal. In the present embodiment, the in-phase and quadrature components of the incoming signals are referred to as I(kΔt) and Q((kΔt), and the stored reference signal is R0(kΔt). I(kΔt) and Q(kΔt) are respectively the k-th samples of the in-phase and quadrature components of the encoded signal, where k=1, 2, . . . K, and K is the number of samples in the interval with duration T. T is the length of a data symbol of the encoded data signal. R0(kΔt) is defined to be the k-th sample of reference signal corresponding to “0” bit.

As shown in FIG. 6, in-phase correlator 625a comprises a digital multiplier 620a and an adder-accumulator 630a. Digital multiplier 620a receives in-phase signal component 610 and digital multiplier 620b receives quadrature signal component 612. Signals 610 and 612 are the in-phase and the quadrature components at the output of a demodulator preceding the decoder. For example, signals 610 and 612 can be the output of the demodulator 206 in FIG. 2.

Template generator module 640 generates a reference signal 641.

In FIG. 6, digital multiplier 620a of in-phase correlator 625a receives reference signal 641, and multiplies reference signal 641 with the received in-phase signal 610 to generate a product [I(kΔt)*R0(kΔt)], denoted by signal 611a.

Adder-accumulator 630a receives signal 611a and performs a summation over all samples within the n-th shifted bit interval [i.e. from time t=(n−½)T to t=(n+½)T] to generate the first in-phase correlation coefficient C_{I0}, denoted by signal 631a, according to the equation,

$${C}_{I 0} ( n ) = {\sum }_{k = \frac{{K}_{n}}{2} + 1}^{\frac{{K}_{n + 1}}{2}} {I ( k Δ t )}^{*} R 0 ( k Δ t ) \qquad ( Equation 10 )$$

This summation spans from the (k=K/2+1)-th sample in the (n−1)-th bit interval to the (k=K/2)-th sample in the n-th bit interval.

The quadrature component of the incoming signal is also processed in a very similar manner. Quadrature correlator 625b comprises a digital multiplier 620b and an adder-accumulator 630b. Digital multiplier 620b receives reference signal 641, and multiplies reference signal 641 with received quadrature signal 612 to generate a product [Q(kΔt)*R0(kΔt)], denoted by signal 611b.

Adder-accumulator 630b receives signal 611b and performs a summation over all samples within the n-th shifted bit interval [i.e. from time t=(n−½)T to t=(n+½)T] to generate the first quadrature correlation coefficient C_{Q0}, denoted by signal 631b, according to the equation,

$${C}_{Q 0} ( n ) = {\sum }_{k = \frac{{K}_{n}}{2} + 1}^{\frac{{K}_{n + 1}}{2}} {Q ( k Δ t )}^{*} R 0 ( k Δ t ) \qquad ( Equation 11 )$$

As in Equation 10, the summation of equation 11 spans from the (k=K/2+1)-th sample in the (n−1)-th bit interval to the (k=K/2)-th sample in the n-th bit interval.

It is to be noted that in contrast to the conventional receiver (discussed above with reference to FIG. 5), the correlators in FIG. 6 calculate the correlation coefficients C_{I0} and C_{Q0} within a half-bit shifted interval. This feature is indicated within adder-accumulator blocks 630a and 630b by the summation “Σ T/2−3T/2”. In other words, it can be said that correlations are performed over the t+T/2 to t+3T/2 (for n=1) to generate correlation coefficients for the data symbol, assuming that the data symbol begins at time t.

Additionally, it should be noted that in contrast to the conventional receiver, the receiver in FIG. 6 uses a single reference signal R0 (reference signal 641) and has a single reference template generator module 640. Correspondingly, the number of correlators in the receiver of the present invention is half the number of correlators in a conventional receiver which typically uses more than one reference signal. For example, the conventional receiver depicted in FIG. 5 uses reference signals R0 and R1. In contrast to a conventional receiver, the single reference signal R0 is a zero-mean waveform (see Equation 1). Therefore, generation of the correlation coefficients according to Equations 10 and 11 eliminates the constant components of the received in-phase and quadrature signal components. Thus, the receiver of the present invention does not need any special means for constant component elimination.

In-phase correlator output signal 631a [in-phase correlation coefficient C_{I0}(n)] is delayed by a period T by the first delay module 635a to generate delayed signal 633a [in-phase delayed correlation coefficient C_{I0}(n−1)]. For example, as described in Equation 10, C_{I0}(n) spans from t+T/2 to t+3T/2, while delayed signal C_{I0}(n−1) spans from t−T/2 to t+T/2, as expressed by the following equation:

$${C}_{I 0} ( n - 1 ) = {\sum }_{k = \frac{{K}_{n - 1}}{2} + 1}^{\frac{{K}_{n}}{2}} {I ( k Δ t )}^{*} R 0 ( k Δ t ) \qquad ( Equation 12 )$$

A first multiplier 645a receives the in-phase correlator output 631a [C_{I0}(n)], and delayed signal 633a [C_{I0}(n−1)]. In some embodiments, first delay module 635a and first multiplier 645a can be individual operational modules. In other embodiments, the first delay module 635a and the first multiplier 645a can be included in an autocorrelator 656a.

Multiplier 645a multiplies signals 631a and 633a (C_{I0}(n) and C_{I0}(n−1), respectively) to generate an in phase cross correlation signal 661a [MI(n)], according to the following equation,
MI(n)=C_{I0}(n)*C_{I0}(n−1), (Equation 13)

Similarly, quadrature correlator output signal 631b is delayed by a period T by second delay module 635b to generate delayed signal 633b. A second multiplier 645b receives the quadrature correlator output 631b [C_{Q0}(n)], and delayed signal 633b [C_{Q0}(n−1)]. In embodiments, second delay module 635b and second multiplier 645b can either be individual operational modules, or be included in an autocorrelator 656b. Multiplier 645b multiplies signals 631b and 633b (C_{Q0}(n) and C_{Q0}(n−1), respectively) to generate a quadrature cross correlation signal 661b [MQ(n)] according to the following equation,
MQ(n)=C_{Q0}(n)*C_{Q0}(n−1), (Equation 14)

Decision module 675 receives in-phase cross correlation signal 661a, and quadrature cross correlation signal 661b, and generates and output signal 690 with the appropriate sign.

Decision module 675 includes an adder 660 and a sign logic module 680. Adder 660 combines signals 661a and 661b to generate integral cross-correlation signal 671 [MI(n)+MQ(n)]. Sign logic module 680 determines the sign of the decoded signal. In an example embodiment, sign logic module 680 includes a first logic module that inverts the sign of integral cross-correlation signal 671, and a second logic module that assigns a data value to the inverted signal. For example, the second logic module assigns a data value of ‘0’ to the output signal 690 if the sign of inverted signal is negative, and a data value of ‘1’ if the sign of the inverted signal is positive. This action can be described by the equation,
Decision signal 690=Decision(n)=−sign[MI(n)+MQ(n)], (Equation 15)

Note that in an embodiment, correlators 625a and 625b of FIG. 6 perform step 412 of the flowchart 410 in FIG. 4B; autocorrelators 656a and 656b of FIG. 6 perform step 414 of the flowchart 410; and decision module 675 of FIG. 6 performs step 416 of the flowchart 410.

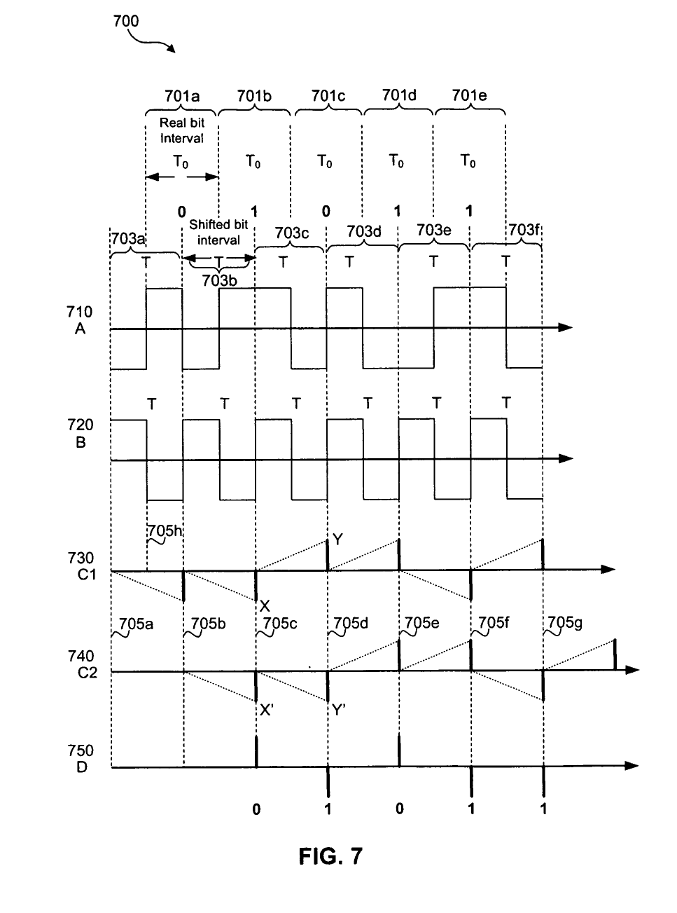

In FIG. 7, operation of the receiver of the present invention is illustrated by showing example signal waveforms 700 generated by various functional modules of the receiver 600. Note that the x-axis for all the waveforms in 700 is time ‘t’.

Signal 710 is an example of a received signal (I or Q component) containing a 5-bit sequence 01011. Note that the received signal can contain any arbitrary bit sequence. Let us assume that signal 710 is the quadrature component Q(kΔt) of the received encoded data signal. The signal in encoded according to the FM0 modulation scheme specified in the Gen2 RFID specifications. Signal 710 is received at the input of the receiver in FIG. 6, for example, as quadrature signal 612. In FIG. 7, 701a, 701b, 701c, 701d, and 701e are ‘real bit intervals’, and 703b, 703c, 703d, 703e, and 703f are ‘shifted bit intervals’. The real bit interval is denoted as To and the shifted bit interval is denoted by T. As shown in FIG. 7, the shifted bit interval is shifted by an amount equal to T/2. Duration of both the real and shifted bit intervals is equal, i.e. T₀ =T. End points of the shifted bit intervals are denoted as 705c, 705d, 705e, 705f, and 705g.

Signal 720 in FIG. 7 shows an example reference signal R0(kΔt). For example, signal 720 can be reference signal 641 generated by template generator 640 in FIG. 6.

Signal 730 in FIG. 7 illustrates the result of the accumulation process performed by the adder-accumulators during the shifted bit interval T. For example, signal 730 can be signal 631b at the output of the adder-accumulator 630b (shown in FIG. 6). Signal 730 is equal to the summation of the products of signals 710 and 720. Signal 730 can represent the correlation coefficient C_{Q0}. A final result at the end of each of the shifted bit interval is indicated in signal 730 with a heavy vertical line.

Signal 740 depicts a correlation coefficient signal delayed by time T by a delay module. For example, signal 740 can be signal 633b [C_{Q0}(n−1)] shown in FIG. 6.

Signal 750 shows the result of multiplying the non-delayed and delayed correlator outputs, i.e. signals 730 and 740 respectively, at the end of the adjacent shifted bit intervals. For example, the first of the two adjacent shifted bit intervals spans from t+T/2 to t+3T/2, i.e. from 705b to 705c, where ‘t’ is the starting point of the first encoded bit, indicated as 705h. The next interval spans from t+3T/2 to t+5T/2, i.e. from 705c to 705d. Signal 750 can represent the product [C_{Q0}(n)*C_{Q0}(n−1)], denoted by the signal 661b in FIG. 6. This multiplication is performed by autocorrelator 656b.

Thus, signal 750 is the resultant transmitted bit waveform at the output of the autocorrelator. Whenever signal 730 and signal 740 have the same sign at the end of a shifted bit interval, the resultant transmitted bit is ‘0’. For example, at the end of the second shifted bit interval, i.e. at 705c, signal 730 has a negative value X. At the same instant, signal 740 has a negative value as well (X′). Hence, the product has a positive value, which is translated as bit ‘0’. On the other hand, at the end of the third shifted bit interval, i.e. at 705d, 730 has a positive value Y, and 740 has a negative value Y′. Thus, the resultant product is negative, which is translated as bit ‘1’. Note that the heavy vertical lines shown in signal 750 correspond to transmitted bit values before a final sign has been assigned to the bits.

The decision module 675 receives the signal 750, and processes the signal 750 according to the logic embedded in the module, an example of which is discussed earlier with reference to FIG. 6.

Some of the example advantages of the present invention are discussed below.

The current method uses a single mean-zero reference. Hence, it simplifies the signal processing operation performed by the base-band part of the receiver compared to the conventional two-reference solution. Also, using a single mean-zero reference eliminates uncertain constant components in the I/Q transforms. Simplified signal processing results in less complex hardware implementation.

The current method, in contrast to the conventional methods, computes correlation coefficients between the received I/Q components and the reference signal within an interval shifted by one half of the bit length relative to the real bit interval. This operation allows the base-band receiver to involve a two-bit interval in making a decision about each transmitted bit. In contrast, in a conventional decoding algorithm, a single bit interval is involved in the decision-making process. Thus, the current method provides a 3 dB energy gain compared to the conventional method.

### CONCLUSIONS

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method for decoding an encoded data signal, comprising:
(a) receiving the encoded data signal including a plurality of data symbols, wherein a time period T is a length of a data symbol of the encoded data signal, wherein a current data symbol begins at time t and ends at time (t+T);
(b) correlating an in-phase component of the received signal with a reference signal over a period t−T/2 to t+T/2 to generate a first in-phase correlation coefficient for the current data symbol;
(c) correlating an in-phase component of the received signal with a reference signal over a period t+T/2 to t+3T/2 to generate a second in-phase correlation coefficient for the current data symbol;
(d) correlating a quadrature component of the received signal with the reference signal over a period t−T/2 to t+T/2 to generate a first quadrature correlation coefficient for the current data symbol;
(e) correlating a quadrature component of the received signal with the reference signal over a period t+T/2 to t+3T/2 to generate a second quadrature correlation coefficient for the current data symbol;
(f) multiplying the first in-phase correlation coefficient with the second in-phase correlation coefficient to produce an in-phase cross-correlation value;
(g) multiplying the first quadrature correlation coefficient with the second quadrature correlation coefficient to produce a quadrature cross-correlation value;
(h) adding the in-phase cross-correlation value and the quadrature cross-correlation value to produce an integral cross correlation value; and
(i) determining a decoded value for the current data symbol based on the integral cross-correlation value.

2. The method of claim 1, wherein the plurality of data symbols are encoded in the encoded data signal according to FM0 encoding.

3. The method of claim 2, wherein the encoded data signal comprises data from a backscattered signal received from a radio frequency identification (RFID) tag.

4. The method of claim 1, wherein step (b) comprises:
computing the first in-phase correlation coefficient C_{I0}(n−1) according to
$${C}_{I 0} ( n - 1 ) = {\sum }_{k = \frac{{K}_{n - 1}}{2} + 1}^{\frac{{K}_{n}}{2}} {I ( k Δ t )}^{*} R 0 ( k Δ t ) ,$$
where
I(kΔt)=k-th sample of the in-phase component of the encoded data signal;
R0(kΔt)=k-th sample of a reference signal;
Kⱼ=K=number of samples within a symbol interval, where index j indicates the time interval in which the summation is performed for decoding the n-th symbol; and
Δt=T/K.

5. The method of claim 4, wherein step (c) comprises:
computing the second in-phase correlation coefficient C_{I0}(n) according to
$${C}_{I 0} ( n ) = {\sum }_{k = \frac{{K}_{n}}{2} + 1}^{\frac{{K}_{n + 1}}{2}} {I ( k Δ t )}^{*} R 0 ( k Δ t ) .$$

6. The method of claim 4, wherein step (f) comprises:
calculating the in-phase cross correlation MI(n) according to
MI(n)=C_{I0}(n)*C_{I0}(n−1).

7. The method of claim 1, wherein step (d) comprises:
computing the first quadrature correlation coefficient C_{Q0}(n−1) according to
$${C}_{Q 0} ( n - 1 ) = {\sum }_{k = \frac{{K}_{n - 1}}{2} + 1}^{\frac{{K}_{n}}{2}} {Q ( k Δ t )}^{*} R 0 ( k Δ t )$$
where
Q(kΔt)=k-th sample of the in-phase component of the encoded data signal;
R0(kΔt)=k-th sample of a reference signal;
Kⱼ=K=number of samples within a symbol interval, where index j indicates the time interval in which the summation is performed for decoding the n-th symbol; and
Δt=T/K.

8. The method of claim 7, wherein step (e) comprises:
computing the second quadrature correlation coefficient C_{Q0}(n) according to
$${C}_{Q 0} ( n ) = {\sum }_{k = \frac{{K}_{n}}{2} + 1}^{\frac{{K}_{n + 1}}{2}} {Q ( k Δ t )}^{*} R 0 ( k Δ t ) .$$

9. The method of claim 7, wherein step (g) comprises:
calculating the quadrature cross correlation MQ(n) according to
MQ(n)=C_{Q0}(n)*C_{Q0}(n−1).

10. The method of claim 1, wherein step (i) comprises:
inverting a sign of the integral cross correlation to produce a determined signed value;
determining the decoded value to be equal to 0 if the determined signed value is negative; and
determining the decoded value to be equal to 1 if the determined signed value is positive.

11. The method of claim 4, wherein the reference signal R0(kΔt) is a function equal to the sign of the signal sin(kΔtΩ), where Ω=2π/T is the subcarrier frequency.

12. The method of claim 7, wherein the reference signal R0(kΔt) is a function equal to the sign of the signal sin(kΔtΩ), where Ω=2π/T is the subcarrier frequency.

13. A base-band digital receiver that decodes an encoded data signal, the encoded data signal including a plurality of data symbols, wherein a time period T is a length of a data symbol of the encoded data signal, wherein a current data symbol begins at time t, the receiver comprising:
an in-phase correlator that correlates an in-phase component of the encoded data signal with a reference signal over a period t+T/2 to t+3T/2 to generate an in-phase correlation coefficient for the current data symbol;
a quadrature correlator that correlates a quadrature component of the received signal with the reference signal over the period t+T/2 to t+3T/2 to generate a quadrature correlation coefficient for the current data symbol;
a first delay module that receives the in-phase correlation coefficient associated with the time period t+T/2 to t+3T/2 while outputting a delayed in-phase correlation coefficient associated with a prior time period t−T/2 to t+T/2;
a second delay module that receives the quadrature correlation coefficient associated with the time period t+T/2 to t+3T/2 while outputting a delayed quadrature correlation coefficient associated with the prior time period t−T/2 to t+T/2;
a first multiplier that multiplies the in-phase correlation coefficient with the delayed in-phase correlation coefficient to produce an in-phase cross-correlation value;
a second multiplier that multiplies the quadrature correlation coefficient with the delayed quadrature correlation coefficient to produce a quadrature cross-correlation value; and
a decision module that adds the in-phase cross-correlation value and the quadrature cross-correlation value to produce an integral cross-correlation value, and determines a decoded value for the current data symbol based on the integral cross-correlation value.

14. The receiver of claim 13, wherein the plurality of data symbols are encoded in the encoded data signal according to FM0 encoding.

15. The receiver of claim 13, wherein the encoded data signal comprises data from a backscattered signal received from a radio frequency identification (RFID) tag.

16. The receiver of claim 13, wherein the in-phase correlator comprises:
a digital multiplier that receives the in-phase signal component of the encoded data signal, and multiplies the in-phase signal component by the reference signal; and
an in-phase adder-accumulator that receives and accumulates an output of the digital multiplier over all samples within a shifted bit interval spanning from t+T/2 to t+3T/2, to generate the in-phase correlation coefficient.

17. The receiver of claim 13, wherein the quadrature correlator comprises,
a digital multiplier that receives the quadrature signal component of the encoded data signal, and multiplies the quadrature component by the reference signal; and
a quadrature adder-accumulator that receives and accumulates an output of the digital multiplier over all samples within the shifted bit interval spanning from t+T/2 to t+3T/2, to generate the quadrature correlation coefficient.

18. The receiver of claim 13, wherein the decision module comprises:
an adder that adds the in-phase cross-correlation value and the quadrature cross-correlation value to produce an integral cross-correlation value;
a first logic module that inverts a sign of the integral cross-correlation value to produce a determined signed value; and
a second logic module that determines the decoded value to be equal to 0 if the determined signed value is negative, or to be equal to 1 if the determined signed value is positive.

19. The receiver of claim 13, further comprising:
a demodulator that demodulates the encoded data signal into the in-phase component and the quadrature component.

20. The receiver of claim 13, further comprising:
a template generator module that generates the reference signal, wherein the in-phase correlator and the quadrature correlator each receives the generated reference signal.
